(19) United States
(12) Patent Application Publication
(10) Pub. No.: US 2024/0428207 A1
(43) Pub. Date: Dec. 26, 2024

(54) CONSUMER INTERFACE APPARATUS AND METHODS OF USE

(71) Applicant: PHILIP MORRIS PRODUCTS S.A., Neuchâtel (CH)

(72) Inventor: Omar ALIJEVIC, Lausanne (CH)

(21) Appl. No.: 18/698,596

(22) PCT Filed: Oct. 3, 2022
(86) PCT No.: PCT/IB2022/059428

§ 371 Date: Apr. 4, 2024

(30) Foreign Application Priority Data
Oct. 7, 2021 (EP) 21201527.5

(51) Int. Cl. G06Q 10/30; B65G 1/04; G06Q 30/0207

(52) U.S. Cl. CPC G06Q 10/30; B65G 1/04; G06Q 30/0237

(57) ABSTRACT

A consumer interfacing apparatus comprising: a retrieval assembly configured to retrieve used consumables from an external container, the external container configured to be placed in mechanical engagement with the consumer interfacing apparatus: a controller operably coupled to the retrieval assembly and configured to collect data regarding at least used consumables retrieved from the external container, wherein the external container or an owner of the external container is awarded with a recycling reward for used consumable retrieved from the container: and an apparatus recycling compartment for storing the used consumables retrieved from the container.

The present disclosure relates to methods of promoting recycling by consumers of consumable products. The present disclosure also relates to methods whereby a container of consumer goods, a consumer and a consumer interface apparatus can interact.

Aerosol-generating articles in which an aerosol-forming substrate for generating an inhalable aerosol is heated, rather than combusted, are known in the art. Typically in such aerosol-generating articles, a portion of the aerosol-generating substrate, referred to as a used consumable remains after the aerosol has been generated. Both unused and used consumables can be stored in consumer owned containers. These containers typically include separate spaces for both used and unused consumables.

According to aspects of the present invention, there is provided a consumer interfacing apparatus that may comprise a retrieval assembly configured to retrieve used consumables from an external container. The external container may be configured to be placed in mechanical engagement with the consumer interfacing apparatus. The consumer interfacing apparatus may also comprise a controller. The controller may be operably coupled to the retrieval assembly and be configured to collect data regarding used consumables retrieved from the external container, optionally other data could also be collected. The external container or an owner of the external container may be awarded with a recycling reward for each used consumable retrieved from the external container. The consumer interfacing apparatus may also comprise an apparatus recycling compartment for storing the used consumables retrieved from the external container.

According to aspects of the present invention, there is provided a system for awarding a container or an owner of the container with one or more recycling rewards. The system may comprise an external container. The external container may comprise a container recycling compartment that may be configured to at least temporarily house one or more used consumables. The external container may be configured to store at least information related to recycling rewards associated with the external container or owner of the external container. Such systems may also comprise a consumer interfacing apparatus that comprises a retrieval assembly configured to retrieve used consumables from the external container. The consumer interfacing apparatus may also comprise a controller. The controller may be operably coupled to the retrieval assembly and be configured to collect data regarding at least used consumables retrieved from the external container. The consumer interfacing apparatus may also comprise an apparatus recycling compartment for storing the used consumables retrieved from the external container. The external container may be configured to be removably placed in mechanical engagement with the consumer interfacing apparatus. The external container or an owner of the external container may be awarded with a recycling reward for used consumables retrieved from the external container by the retrieval assembly. In some instances, the external container can contain a memory function so that the recycling rewards can be attributed to the external container. In some instances, the consumer can voluntarily sign up in an online database that attributes the external container to themselves, and the recycling rewards can be saved in the online database. In some instances, the recycling reward can be a physical object that is distributed to the consumer by the consumer interfacing apparatus and the consumer can save the rewards on their own.

According to aspects of the present invention, there is provided methods of awarding a consumer recycling rewards for the return of used consumables generated by use of an aerosol generating device. The method may comprise removably placing an external container in mechanical engagement with a consumer interfacing apparatus. The method may also comprise retrieving at least one used consumable from the external container via a retrieval assembly of the consumer interfacing apparatus. Additionally, the method may comprise awarding the external container or an owner of the external container with a recycling reward for used consumable retrieved from the external container by the retrieval assembly of the consumer interfacing apparatus. The recycling reward can be awarded for each used consumable or some amount other than a one to one ratio of recycling rewards to used consumables.

Consumer interfacing apparatuses disclosed herein may additionally comprise a new storage compartment for storing unused consumables. In such consumer interfacing apparatuses, the retrieval assembly of the consumer interfacing apparatus may be configured to dispense new consumables from the new storage compartment into the external container. In some such consumer interfacing apparatuses, the external container may comprise a new consumable compartment configured to at least temporarily house the new consumables dispensed from the consumer interfacing apparatus.

The methods, systems, and apparatuses of the invention may encourage consumers to recycle more used consumables than they would otherwise.

Disclosed methods, systems, and apparatuses of the invention may be configured to provide credit to users or the external container itself for recycling used consumables. Additionally, methods, systems and apparatuses of the invention may afford the opportunity to interact with consumers so that the consumers can obtain additional unused consumables, additional goods, or information. Information may also be obtained from the consumer via the interaction with the systems and apparatuses of the invention. Additionally, methods, systems and apparatuses of the invention may afford the ability to ensure that only authorized users are obtaining unused consumables by verifying information associated with the external container, an associated aerosol generating device, information associated with the aerosol generating device stored by an application on an external electronic device (for example, a smart phone), or any combination thereof. Disclosed methods, systems and apparatuses of the invention affords the ability to interact with a consumer interact with or without the use of an application on an external electronic device (for example, a smart phone).

By offering rewards for recycling used consumables, which may be able to be used for obtaining additional consumables, other goods (for example, non-aerosol generating related, charging of aerosol generating device or electronic devices generally, or the like), or other consumer-appealing rewards (for example, donation of credit to a third-party cause) the invention will obtain more recycling by consumers. Disclosed methods, systems and apparatuses of the invention may offer advantages over the prior art by allowing users to more easily obtain additional unused consumables at any time and with the ability to more easily tailor those obtained. The ability to recycle used consumables at any time—not only when all consumables are used but before all are used—affords users more options to recycle, which should promote more recycling by consumers.

As used herein, the singular forms “a,” “an,” and “the” also encompass embodiments having plural referents, unless the content clearly dictates otherwise.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

As used herein, an “aerosol generating device” is a device that generates an aerosol that may be inhaled by a user or that delivers a particle to a user's lungs when the user draws on the aerosol generating device. The aerosol generating device may be a device that heats, but does not combust an aerosol generating substrate, such as a substrate that comprises tobacco. The aerosol generating device may comprise a device that heats, vaporizes, or nebulizes a liquid to cause aerosol formation. The liquid may comprise nicotine. The aerosol generating device may comprise a powder inhaler, such as a dry powder inhaler, configured to deliver particles to a user. The particles may comprise nicotine. The particles may be sized, and the device may be configured, such that the particles are delivered to a user's lungs when the user draws on the aerosol generating device.

The term “aerosol-producing article” or “aerosol-producing substrate” refers to a substrate capable of releasing, upon heating, volatile compounds, which can form an aerosol. The aerosols generated from aerosol-producing substrates of aerosol generating articles according to the present disclosure may be visible or invisible and may include vapours (for example, fine particles of substances, which are in a gaseous state, that are ordinarily liquid or solid at room temperature) as well as gases and liquid droplets of condensed vapours.

The term “controller” and “processor” refers to any device or apparatus capable of providing suitable computing capabilities and control capabilities such as, for example, microprocessors, digital signal processors (DSP), application specific integrated circuits (ASIC), field-programmable gate arrays (FPGA), equivalent discrete or integrated logic circuitry, or any combination thereof and of providing suitable data storage capabilities that includes any medium (for example, volatile or non-volatile memory, a CD-ROM, magnetic recordable medium such as a disk or tape, or the like) containing digital bits (for example, encoded in binary, trinary, or the like) that may be readable and/or writeable.

The term “communication interface” refers to any device or apparatus capable of providing suitable data communication capabilities between an aerosol-generating device and a user interface device such as, for example, various telemetry circuits and antennas and may use one or more wired or wireless (for example, radio frequency) data transmission protocols such as, for example, BLUETOOTH, WI-FI, any protocol in the ultra-high frequency (UHF) band, any protocol in the super high frequency (SHF) band, low frequencies, or combinations thereof.

The term “database” refers to a collection, set, or repository of queryable, associable data such as, for example, a relational database.

As discussed above, aerosol generating devices produce a used consumable after the aerosol has been generated from an aerosol generating article. Unused consumables, which can include aerosol generating articles are typically provided to consumers or can be stored by consumers in an external container. Upon utilizing an unused consumable to generate the aerosol, the consumer may then place the used consumable into the external container. The external container may comprise a separate compartment or multiple separate compartments for storage of the used consumables.

Disclosed apparatuses, systems and methods can be utilized with external containers for example. The external containers may optionally include one or more compartments for storage of unused consumables as well. Additionally, some external containers may optionally include compartments for storage of aerosol generating devices as well as other devices or articles.

The consumer interfacing apparatus may comprise a housing of any suitable shape or size. The housing has a size and shape that provides for a structure suitable for assembling all other components. The housing may comprise a top, bottom, front, left side, right side and back. The front may comprise one or more windows for viewing consumables or dispensable components or devices stored in the consumer interfacing apparatus. Preferably, at least one side of the housing or portion of the housing may be opened to perform maintenance on the consumer interfacing apparatus. Preferably, the openable side or portion of the housing is lockable and unlockable to provide access, such as keyed access, to authorized personnel. Preferably, the housing comprises anchor elements to allow the consumer interfacing apparatus to be anchored to its surroundings, such as to a floor, a wall, a pillar, or the like. The housing may be formed from one or more suitable material, such as a metal or metallic material, a glass material, or a plastic material. Preferably at least a portion of the housing provides a surface on which a graphic element may be displayed. Contained within the housing is a compartment or container to house the used consumables that are obtained from consumers through usage of the consumer interfacing apparatus for recycling their used consumables.

The consumer interfacing apparatus may comprise a power supply. The power supply preferably comprises an alternating current power supply. The power supply may comprise a battery. Preferably, the consumer interfacing apparatus comprises a backup power supply system. Preferably the backup power supply system comprises one or more batteries with sufficient capacity to allow any transaction in process to be completed if main power is lost during the transaction. For example, the backup power supply may comprise one or more batteries with sufficient capacity to allow the consumer interfacing apparatus to be fully functional for at least 10 minutes once the main power has been lost.

The consumer interfacing apparatus may comprise circuits and wiring to connect all electronic components in the consumer interfacing apparatus to supply power to the components and allow the components to exchange data with each other as well as with external components.

The consumer interfacing apparatus may be configured to provide data regarding its status to a remote server via network apparatus via a wired or wireless connection. The data regarding status may include the amount of used consumables recycled, the amount of unused consumables present, replacement parts, replacement devices, accessories, and other dispensable articles remaining in the consumer interfacing apparatus. If the amount of used consumables is high, an alert may be sent by the consumer interfacing apparatus or remote sever to prompt personnel to empty the used consumables from the consumer interfacing apparatus. If the amount of unused consumables remaining is low, an alert may be sent by the vending apparatus or remote server to prompt personnel to restock the article. The data regarding the status of the consumer interfacing apparatus may include a report indicating recycling rewards awarded from the consumer interfacing apparatus.

The consumer interfacing apparatus may be configured and may contain components to allow a user to connect to a remote service center. Connection to the remote service center may allow the user to contact a person to provide notice of a problem associated with the transaction or interaction with the consumer interfacing apparatus or to ask questions regarding how to properly operate the consumer interfacing apparatus. The consumer interfacing apparatus may comprise a microphone and speaker, along with phone, Voice Over Internet Protocol apparatus, or modem to connect the remote service center. If the consumer interfacing apparatus comprises a display and camera, contact with the remote service center personnel may be in the form of a video conference. Personnel from the remote service center may be able to provide instructions or recommendations regarding aerosol generating device repair based on data regarding the aerosol generating device received by the consumer interfacing apparatus. Personnel from the remote service center may be able to remotely control one or more functions of the consumer interfacing apparatus.

The consumer interfacing apparatus may optionally comprise one or more optical sensors. For example, the consumer interfacing apparatus may comprise one or more cameras. Preferably the camera faces a direction in which the user is most likely to stand when interacting with the consumer interfacing apparatus. The optical sensors may be operably coupled to the controller which may be coupled with facial recognition software stored locally in memory of the consumer interfacing apparatus or accessible via a remote server.

The consumer interfacing apparatus may comprise a module to recharge the battery of a user's aerosol generating device. The recharge module may recharge the battery of the aerosol generating device through physical connection or through a wireless recharging system, such as an inductive recharging system. The recharge module may comprise a cavity in the housing of the consumer interfacing apparatus in which a user may place their aerosol generating device. The recharge module may comprise one or more suitable connectors for physical connection to the aerosol generating device.

Disclosed consumer interfacing apparatuses include at least a retrieval assembly; a controller and an apparatus recycling compartment. These components, as well as optional additional components, form a consumer interfacing apparatus that functions to retrieve used consumables from an external container and communicate data regarding or relating to the used consumables from the consumer interfacing apparatus to an owner of the external container.

The retrieval assembly may be configured to retrieve at least one used consumable from an external container. The retrieval assembly may comprise any suitable components for retrieving at least one used consumable from the external container. The retrieval assembly may be controlled to be mechanically engaged with the external container, or more specifically the used consumable compartment of the external container, when the external container may be in contact with the interfacing apparatus. For example, the retrieval assembly may comprise a robotic arm that may raise or lower from a shaft and rotate or pivot relative to the shaft. The robotic arm may telescope or otherwise extend and contract as appropriate to retrieve the used consumable(s). The robotic arm may include pincers to grasp and release the used consumable(s).

The controller may be operably coupled to the retrieval assembly and be configured to collect data regarding at least the used consumable retrieved from the external container. The controller may also function to award the external container or an owner of the external container with a recycling reward for each unused consumable retrieved from the container by the consumer interfacing apparatus. For example, the external container may have a memory function to retain the reward, or an identifier that allows the award to be attributed to the container, for example in a database etc. Alternatively, the recycling reward may be an object, for example a piece of paper or other physical carrier like a coin etc. that is distributed by the machine so the consumer can retain it.

The recycling rewards may be utilized for various purposes, as chosen by the owner of the external container from which the used consumable was obtained. For example, the recycling reward could be used for obtaining unused consumables, other goods (for example aerosol generating related goods, non-aerosol generating related goods, or the like), charging of aerosol generating related goods or non-aerosol generating related goods, or combinations thereof. The recycling reward can be used instantly upon the receipt of the reward from the consumer interfacing apparatus or can be associated with the particular individual so that the recycling rewards can be stored and an aggregate amount can be utilized to obtain goods or other desired features. The recycling rewards, if not a physical object, can be stored in a memory function of the external container, in a database accessible by consumer interfacing apparatuses, etc.

The controller may optionally receive data from the external container regarding the aerosol generating device. The controller may be configured to cause networking apparatus to transmit data regarding the aerosol generating device to a remote server and receive data from a remote server regarding one or both of (i) which choices of consumable or other vendable articles to present to the user based on the data regarding the aerosol generating device, and (ii) whether the aerosol generating device may benefit from repair based on the data regarding the aerosol generating device. The server to which the data is sent and the server from which the data is received may be the same or different. The consumer interfacing apparatus may contain any suitable network apparatus to send and receive information from a remote server. For example, the consumer interfacing apparatus may comprise a modem.

Computational aspects associated with the data may be performed by the controller, a remote server, or both the controller and a remote server. Computational aspects may be shared between the controller and a remote server. One or more computational aspects may be redundant or non-redundant between the controller and a remote server.

The computer program products used to implement the processes described herein may be provided using any programmable language, for example, a high-level procedural or object orientated programming language that is suitable for communicating with a computer system. Any such program products may, for example, be stored on any suitable device, for example, a storage media, readable by a general or special purpose program, controller apparatus for configuring and operating the computer when the suitable device is read for performing the procedures described herein. At least in one embodiment, the consumer interfacing apparatus may be implemented using a non-transitory computer readable storage medium, configured with a computer program, where the storage medium so configured causes the computer to operate in a specific and predefined manner to perform functions described herein.

The exact configuration of the controller of the consumer interfacing apparatus is not limiting and essentially any device capable of providing suitable computing capabilities and control capabilities to implement the illustrative methods described herein may be used. The functionality as described in one or more embodiments according to the present invention may be implemented in any manner as would be known to one skilled in the art. As such, the computer language, the controller, or any other software or hardware which is to be used to implement the processes described herein shall not be limiting on the scope of the systems, processes or programs (for example, the functionality provided by such processes or programs) described herein. The methods and processes described in this disclosure, including those attributed to the systems, or various constituent components, may be implemented, at least in part, in hardware, software, firmware, or any combination thereof. For example, various aspects of the techniques may be implemented within one or more processors, including one or more microprocessors, DSPs, ASICs, FPGAs, CPLDs, microcontrollers, or any other equivalent integrated or discrete logic circuitry, as well as any combinations of such components. When implemented in software, the functionality ascribed to the systems, devices, and methods described in this disclosure may be embodied as instructions on a computer-readable medium such as RAM, ROM, NVRAM, EEPROM, FLASH memory, magnetic data storage media, optical data storage media, or the like. The instructions may be executed by one or more processors to support one or more aspects of the functionality described in this disclosure.

During the interaction of the consumer with the consumer interfacing apparatus, data may be exchanged. The data can be exchanged between any of the involved components in any suitable fashion. Any of the devices, systems, or apparatuses (for example, the consumer interfacing apparatus, the external container, the aerosol generating device, intermediary device, or any combinations thereof) may comprise one or more wired or wireless communication modules for communicating with any of the other devices (for example, the consumer interfacing apparatus, the external container, the aerosol generating device, intermediary device, or any combinations thereof).

The consumer interfacing apparatus may include an interface configured to allow a user to select one or more of an unused consumable for use with an aerosol generating device. The consumer interfacing apparatus may be operably coupled to the controller, which may cause the consumer interfacing apparatus to present choices of one or more unused consumables, to the user based on the data regarding past usage of the aerosol generating device. The consumer interfacing apparatus may comprise a display to visually present the choices to the user or other suitable output apparatus. The consumer interfacing apparatus may comprise input apparatus to allow the user to select from the presented choices. Examples of input apparatus include a touchscreen, which may also serve as a display, a microphone, a knob, a dial, a switch, a button, a joystick, a trackball, a keyboard, a touch surface, a slider, a pressure sensor, a capacitive sensor, a resistance sensor, a conductive sensor, a mouse, and the like.

The consumer interfacing apparatus may include appropriate ports, receivers, such as antenna, transmitters, or transceivers to communicate with one or both of an aerosol generating device and an intermediary device, which may include a mobile phone, a smartphone, a tablet, a smartwatch, a fitness tracker, a wearable device, smart glasses, or a portable computing device. The consumer interfacing apparatus may include communication apparatus configured to communicate over a number of different protocols to allow for interaction with a vast number of aerosol generating devices and intermediary devices or may include communication apparatus configured to communicate over one or a few different protocols to allow for selective interaction with a limited number of aerosol generating devices and intermediary devices. Communication apparatus preferably includes a telemetry circuit and an antenna for bidirectional communication with other devices.

Communication between the consumer interfacing apparatus and any other user devices or components of user devices may occur via physical connection or wireless connection. Examples of physical connection include wired connection through, for example, a USB (Universal Serial Bus) connection, a lightning connector, or any other suitable connection or connector. Wireless communication may include radio frequency based connection such as near field communication (NFC), Bluetooth, Bluetooth Low-energy, Wireless USB, Wi-Fi, White-Fi, WiFi HalLow, Wi-FAR, WRAN, WLAN, LPWAN (Sigfox, LoRa, INGenu, Wait, NB-Iot, LTE-M, Telensa, CYANconnode, Weightless), phone data connection (GPRS, LTE, 3G, 4G, 5G), zigbee, z wave, RuBee, and TransferJet. Wireless communication may include light based communication such as Infrared, Li-Fi, Optical (camera in combination with a QR code, a DotCode or a barcode). Wireless communication may include sound-based communication such as sonic communication. Wireless communication may include magnetic communication such as Near-field magnetic induction communication (NFMI).

Communication between the consumer interfacing apparatus and other devices or components of devices may be initiated in any suitable manner. For example, physical connection of one or both of the external container and an intermediary device may initiate communication. The consumer interfacing apparatus and one or both of the aerosol generating device and the external container or an intermediary device may detect each other through wireless communication. The vending apparatus may send a request, via the communication apparatus, to one or both of the consumer interfacing apparatus and the intermediary device through a physical data connection or wireless connection. The consumer interfacing apparatus may receive a connection request, via the communication apparatus, from one or both of the aerosol generating device and the intermediary device. Connection may be automatic upon request or may require approval by one or more of the consumer interfacing apparatus, the aerosol generating apparatus, and the intermediary device.

Any suitable data regarding the aerosol generating device may be received by the consumer interfacing apparatus, for example. Such information that the consumer may want to share with the consumer interfacing apparatus includes one or more of identification number of the device; product serial number; installed software or firmware version; status, such as operating status, of the device or one or more components of the device; user's preferred brand of consumables; preferred taste of consumables; preferred type of consumables; usage history of the aerosol generating device; and types and flavours of consumables previously used with the device. Any information gathered by the consumer interfacing apparatus is information that has been approved by the consumer.

Data regarding usage history of the device may include, for example, the location of prior use of the device; duration of prior sessions of use of the device; temperature of a heating element; airflow; humidity; power consumption; number of puffs during prior sessions; duration of puffs, airflow during each puff; consumables employed, amount of consumables consumed during a prior session; time, location, and duration of charging of a battery of the device; time of prior maintenance or cleaning; location and time when prior errors occurred; when and where the device was manufactured; when and where the device was sold; and the like.

Other information that the consumer may want to share with the consumer interfacing apparatus, or other device, includes preferred tastes and flavours the user prefers in other products such as food and drinks.

User preferences, which may be input to the aerosol generating device via an intermediary device, for example following user responses to a questionnaire, or the like, may be stored in memory of the aerosol generating device. Such user preference information may be transmitted to the consumer interfacing apparatus.

The consumer interfacing apparatus may receive information regarding the status of the aerosol generating device or one or more components of the aerosol generating device. Status data may include battery capacity, battery charge level, current or prior resistance or impedance of heating element, battery capacity needed to power heating element, operational status of one or more sensors, and the like. The status data may be data obtained by interrogating the device and running a systems check or may be information stored in memory by the device.

The consumer interfacing apparatus may display aspects related to status data obtained from the device, may provide recommendations for repair or maintenance of the device, may provide recommendations for replacement parts that may be used with the device, may provide recommendations for replacing the device, or the like.

Regardless of the data obtained, the consumer interfacing apparatus may obtain data regarding the aerosol generating device from the aerosol generating device, from an intermediary device, or both from the aerosol generating device and the intermediary device. The consumer interfacing apparatus may receive the data from any suitable intermediary device, such as a personal computing device, for example a smart phone, or the like. The intermediary device may communicate with the aerosol generating device contemporaneously with communicating with the consumer interfacing apparatus to obtain data regarding the aerosol generating device. In addition or alternatively, the intermediary device may have stored data regarding the device obtained from prior communication with the device or obtained from user input regarding the device and user preferences.

The aerosol generating device, the intermediary device, or both the aerosol generating device and the intermediary device may include communication apparatus for transmitting data regarding the aerosol generating device to the consumer interfacing apparatus. The communication apparatus may be passive or active. Passive communication apparatus may include a bar bode, or other identifying feature that may be scanned by an appropriate reader of the consumer interfacing apparatus. The communication apparatus may include an RFID (Radio-Frequency Identification) tag having information regarding the aerosol generating device, and the consumer interfacing apparatus may have an RFID reader to interrogate the RFID tag. The RFID tag may be active or passive.

The consumer interfacing apparatus may have access to a database that may include data from owners of external containers that may further be associated with owners of aerosol generating devices. The described database may include a set of user data such as, for example, a user account associated with each verified user. In one or more aspects of the present invention, each user account of the database is associated with a person who is verified to be of legal age to use the aerosol-generating devices. The described database may further include a set of aerosol-generating device data such as, for example, unique device-identification information identifying each aerosol-generating device (for example, a serial number). The user account and unique device-identification information may be associated with each other in the database when a user unlocks one or more unlockable features of the aerosol-generating device upon, for example, purchase of the aerosol-generating device. Conversely, the user account and unique device-identification information may be disassociated with each other in the database when a user relocks one or more unlockable features of the aerosol-generating device upon, for example, sale or other disposal of the aerosol-generating device. In other words, the unique device-identification information (for example, a serial number) may be linked to only one user account and the aerosol-generating device can only be unlocked (for example, the one or more unlockable features will unlock) when the unique device-identification information has been linked to a user account. Further, when the aerosol-generating device is unlinked with the associated user account, the aerosol-generating device will automatically lock (for example, the one or more unlockable features will lock).

Disclosed methods allow interface between three entities, the consumer interfacing apparatus, an owner of an external container holding a used consumable (either directly or through a user peripheral) and the external container from which the used consumable can be obtained by the consumer interfacing apparatus. Methods include retrieving at least one used consumable from an external container via a retrieval assembly of the consumer interfacing apparatus and awarding the external container or an owner thereof with a recycling reward for each used consumable retrieved from the external container by the retrieval assembly of the consumer interfacing apparatus. Methods can also include removably placing the external container in mechanical engagement with the consumer interfacing apparatus.

Methods can optionally include transmission of additional data related to the owner of the external container, an aerosol-generating device owned by the owner of the external container, a peripheral device co-owned by the owner of the external container, or any combination thereof. Such data transmission would have full approval by the consumer. Methods can optionally include a step of dispensing unused consumables either as a function of the recycling reward or as a function of payment.

Below there is provided a non-exhaustive list of non-limiting examples. Any one or more of the features of these examples may be combined with any one or more features of another example, embodiment, or aspect described herein.

Example 1 includes a consumer interfacing apparatus comprising: a retrieval assembly configured to retrieve used consumables from an external container, the external container configured to be placed in mechanical engagement with the consumer interfacing apparatus; a controller operably coupled to the retrieval assembly and configured to collect data regarding at least used consumables retrieved from the external container, wherein the external container or an owner of the external container is awarded with a recycling reward for used consumable retrieved from the container; and an apparatus recycling compartment for storing the used consumables retrieved from the container.

Example 2 is a consumer interfacing apparatus according to Example 1, wherein the retrieval assembly comprises a robotic arm.

Example 3 is a consumer interfacing apparatus according to Examples 1 or 2, the consumer interfacing apparatus further comprising a new storage compartment for storing unused consumables.

Example 4 is a consumer interfacing apparatus according to Example 3, wherein the retrieval assembly is further configured to place unused consumables from the new storage compartment of the consumer interfacing apparatus into the external container.

Example 5 is a system for rewarding a container or an owner of the container with one or more recycling rewards, the system comprising: an external container, the external container comprising a container recycling compartment configured to at least temporarily contain one or more used consumable, and a consumer interfacing apparatus comprising: a retrieval assembly configured to retrieve used consumables from the external container; a controller operably coupled to the retrieval assembly and configured to collect data regarding at least the used consumables retrieved from the external container; and an apparatus recycling compartment for storing the used consumables retrieved from the container, wherein the external container is configured to be removably placed in mechanical engagement with the consumer interfacing apparatus, the external container or an owner of the external container is awarded a recycling reward for the used consumables retrieved from the container recycling compartment of the external container by the retrieval assembly.

Example 6 is a system according to Example 5, wherein the retrieval assembly is additionally configured to dispense unused consumables from the consumer interfacing apparatus into the external container.

Example 7 is a system according to Example 6, wherein the external container further comprises an unused compartment.

Example 8 is a system according to any of Examples 5 to 7, wherein the external container is configured to have data associated with it.

Example 9 system according to Example 8, wherein the data associated with the external container is associated with an intermediary device.

Example 10 is a method of awarding a consumer recycling reward for the return of used consumables generated by use of an aerosol generating device, the method comprising: removably placing an external container in mechanical engagement with a consumer interfacing apparatus; retrieving at least one used consumable from the external container via a retrieval assembly of the consumer interfacing apparatus; and awarding the external container or an owner of the external container with a recycling reward for the used consumable retrieved from the external container by the retrieval assembly of the consumer interfacing apparatus.

Example 11 is a method according to Example 10, further comprising the consumer interfacing apparatus collecting data related to the external container or an owner thereof.

Example 12 is a method according to Example 11, wherein the collected data relates to information related to recycling rewards owned by the owner of the external container.

Example 13 is a method according to Example 11, wherein the collected data relates to specifics about the used consumables retrieved from the external container, unused consumables contained in the external container, unused consumables previously contained in the external container, or combinations thereof.

Example 14 is a method according to Example 11, wherein the collected data relates to desired additional unused consumables to be dispensed into the external container.

Example 15 is a method according to any of Examples 10 to 14, wherein the consumer interfacing apparatus, the external container or both can receive and transmit data to an external electronic user device.

The Examples will now be further described with reference to the figures in which:

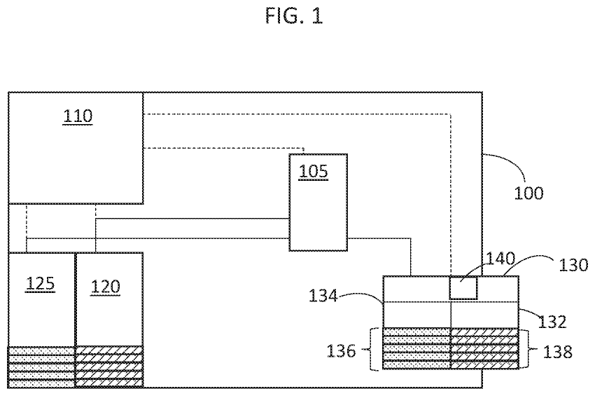

FIG. 1 is an illustrative consumer interfacing apparatus 100. The consumer interfacing apparatus can include at least a retrieval assembly 105, a controller 110, and an apparatus recycling compartment 125. The retrieval assembly 105 is electrically connected to the controller 110. The retrieval assembly 105 is also in reversible contact with the apparatus recycling compartment 125 in that it can obtain used consumables 136 from an external container 130 and dispose them in the apparatus recycling compartment 125. In the depicted embodiment, the used consumables 136 are housed in a container recycling compartment 134 of the external container.

The controller 110 may also be optionally in electrical connection with the apparatus recycling compartment 125 so that it may monitor the number of used consumables in the apparatus recycling compartment 125. In some instances, as the apparatus recycling compartment 125 begin to fill up, the controller 110 may send an alert to a service technician so that the apparatus recycling compartment can be emptied before the consumer interfacing apparatus is unable to accept additional used consumables.

The consumer interfacing apparatus 100 may also optionally include an unused compartment 120 that includes unusable consumables 138. In such embodiments, the consumer interfacing apparatus 100 may be able to dispense unused consumables 138 to the external container 130. In some embodiments, the unused consumables 138 can be dispensed into the unused compartment 132 of the external container 130.

The controller 110 may also be optionally in electrical connection with the unused compartment 120 so that it may monitor the amount, type, or both of unused consumables in the unused compartment 120. In some instances, as the unused compartment 120 begins to empty, or be without certain types of unused consumables 138, the controller 110 may send an alert to a service technician so that the unused compartment can be restocked before the consumer interfacing apparatus is unable to accept additional orders for unused consumables.

The external container 130 may also optionally include an information carrier 140. The information carrier 140 can be any type of computer-readable medium such as RAM, ROM, NVRAM, EEPROM, FLASH memory, magnetic data storage media, optical data storage media, or the like and may contain any type of data. For example, data related to the external container itself (for example, size, capacity, components, or the like), the owner of the external container, one or more aerosol-generating devices associated with the external container, or any combination thereof, may be contained within or on the information carrier 140. Alternatively, the information carrier 140 can include a unique code, for example a QR code, that has been previously associated with a particular consumer, so the apparatus only needs to cross reference the information read from the information carrier of the external container to then credit the owner, for example.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±2% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. A system comprising:
an external container;
a consumer interfacing apparatus comprising:
a retrieval assembly configured to retrieve used consumables from the external container, the external container configured to be placed in mechanical engagement with the consumer interfacing apparatus, wherein each of the used consumables comprises a portion of an aerosol-generating substrate remaining after use of a consumable;
a controller operably coupled to the retrieval assembly and configured to collect data regarding at least used consumables retrieved from the external container, wherein the external container or an owner of the external container is awarded with a recycling reward for used consumable retrieved from the container; and
an apparatus recycling compartment for storing the used consumables retrieved from the container.

2. The consumer interfacing apparatus according to claim 1, wherein the retrieval assembly comprises a robotic arm.

3. The consumer interfacing apparatus according to claim 1, the consumer interfacing apparatus further comprising a new storage compartment for storing unused consumables.

4. The consumer interfacing apparatus according to claim 3, wherein the retrieval assembly is further configured to place unused consumables from the new storage compartment of the consumer interfacing apparatus into the external container.

5. A system for rewarding a container or an owner of the container with one or more recycling rewards, the system comprising:
an external container, the external container comprising a container recycling compartment configured to at least temporarily house one or more used consumable; and
a consumer interfacing apparatus comprising:
a retrieval assembly configured to retrieve used consumables from the external container;
a controller operably coupled to the retrieval assembly and configured to collect data regarding at least the used consumables retrieved from the external container; and
an apparatus recycling compartment for storing the used consumables retrieved from the external container,
wherein the external container is configured to be removably placed in mechanical engagement with the consumer interfacing apparatus, the external container or an owner of the external container is awarded a recycling reward for the used consumables retrieved from the container recycling compartment of the external container by the retrieval assembly.

6. The system according to claim 5, wherein the retrieval assembly is additionally configured to dispense unused consumables from the consumer interfacing apparatus into the external container.

7. The system according to claim 6, wherein the external container further comprises an unused compartment.

8. The system according to claim 5, wherein the external container is configured to store data associated with it.

9. The system according to claim 8, wherein the data associated with the external container is associated with an intermediary device.

10. A method of awarding a consumer a recycling reward for the return of used consumables generated by use of an aerosol generating device, the method comprising:
removably placing an external container in mechanical engagement with a consumer interfacing apparatus;
retrieving at least one used consumable from the external container via a retrieval assembly of the consumer interfacing apparatus; and
awarding the external container or an owner of the external container with a recycling reward for the used consumable retrieved from the external container by the retrieval assembly of the consumer interfacing apparatus.

11. The method according to claim 10, further comprising the consumer interfacing apparatus collecting data related to the external container or an owner thereof.

12. The method according to claim 11, wherein the collected data relates to information related to recycling rewards owned by the owner of the external container.

13. The method according to claim 11, wherein the collected data relates to specifics about the used consumables retrieved from the external container, unused consumables contained in the external container, unused consumables previously contained in the external container, or combinations thereof.

14. The method according to claim 11, wherein the collected data relates to desired additional unused consumables to be dispensed into the external container.

15. The method according to claim 10, wherein the consumer interfacing apparatus, the external container or both can receive and transmit data to an external electronic user device.
